(19) United States
(12) Patent Application Publication
(10) Pub. No.: US 2014/0229312 A1
(43) Pub. Date: Aug. 14, 2014

(54) AUCTION ITEM LISTING GENERATION

(71) Applicants: Jayasimha Nuggehalli, Cupertino, CA (US); Zhenyu Lu, Cupertino, CA (US)

(72) Inventors: Jayasimha Nuggehalli, Cupertino, CA (US); Zhenyu Lu, Cupertino, CA (US)

(73) Assignee: Ricoh Company, Ltd., Tokyo (JP)

(21) Appl. No.: 13/763,950

(22) Filed: Feb. 11, 2013

(51) Int. Cl. G06Q 30/08

(52) U.S. Cl. CPC G06Q 30/08
USPC 705/26.3

(57) ABSTRACT

Techniques are provided for generating an auction item listing for an auction site. Generating an auction item listing comprises: receiving item identification data and item image data, wherein the item identification data uniquely identifies an item and the item image data comprises a digital representation of the item; retrieving item attribute data for the item using the item identification data, wherein the item attribute data specifies one or more attributes of the item; and causing, based upon both at least a portion of the item attribute data and at least a portion of the item image data, auction listing data to be generated and made available via an auction site.

### FIELD OF THE INVENTION

Embodiments relate generally to generating auction item listings, and more specifically, to streamlining the process of generating and posting auction item listings on an auction site.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Preparing an auction item listing and uploading the auction item listing to an auction site is usually challenging and time consuming. It usually requires performing various types of data processing, accessing different devices, and integrating data from different sources and media. For example, a user who would like to auction an item on an online auction site needs to know how to create an auction item listing, how to describe the item, how to price the item, and how to define a shipment policy or return policy for the item. Further, the user needs to know how to identify and depict the item, and how to incorporate a picture of the item into an auction item listing. All these steps may require a certain level of knowledge and familiarity with the technology and various media.

In addition to learning how to perform the above tasks, a user needs to actually take the time to perform the tasks. However, in the process of creating an auction item listing, a user may encounter difficulties in obtaining an item picture that has the format and size required by an auction site. Further, a user may encounter difficulties in creating an auction item listing that meets the requirements of an auction site. Hence, completing the tasks of generating an auction listing may take a relatively long period of time. In some cases, a user may become discouraged by the complexity of the process and refrain from using online auction sites in the future.

### SUMMARY

An apparatus is provided for generating an auction item listing for an auction site. The apparatus comprises one or more processors and memory. The memory stores instructions which, when processed by the one or more processors, cause item identification data and item image data to be received. The item identification data uniquely identifies an item, and the item image data comprises a digital representation of the item. Item attribute data for the item is retrieved using the item identification data. The item attribute data specifies one or more attributes of the item. Auction listing data is generated based upon both at least a portion of the item attribute data and at least a portion of the item image data. The auction listing data is made available on an auction site as an auction item listing.

### BRIEF DESCRIPTION OF THE DRAWINGS

In the figures of the accompanying drawings like reference numerals refer to similar elements.

FIG. 1 is a block diagram that depicts an example of an auction item listing generator.

FIG. 2 is a block diagram that depicts an example of an auction item listing generator receiving data from an electronic mail server.

FIG. 3 is a block diagram that depicts an example of an auction item listing generator receiving data from a server.

FIG. 4 depicts a flow diagram of an example of an auction item listing generator integrated in a client device.

FIG. 5 is a flow diagram that depicts an example of initializing an auction listing generating process.

FIG. 6 depicts an example screen snapshots of initializing an auction listing generating process.

FIG. 7A depicts an example screen snapshot of a login screen of an auction site.

FIG. 7B depicts an example screen snapshot of an authorization screen of an auction site.

FIG. 7C depicts an example screen snapshot of a web page displaying a method for transferring data to a processing service.

FIG. 8 is a flow diagram that depicts an example configuring of a client device.

FIG. 9 is a flow diagram that depicts an example acquiring of item identification data and item image data by a client device.

FIG. 10A is a flow diagram that depicts an approach for acquiring item identification data and item image data by a processing service from a file transfer folder.

FIG. 10B is a flow diagram that depicts an approach for acquiring item identification data and item image data by a processing service from an email folder.

FIG. 10C is a flow diagram that depicts an approach for acquiring item identification data and item image data by a processing service from a post.

FIG. 11 is a flow diagram that depicts an example process of generating an auction item listing.

FIG. 12 depicts an example of an auction item listing displayed on an auction site.

FIG. 13 depicts examples of data structures used by a processing service.

FIG. 14A depicts an example login screen view generated by a processing service.

FIG. 14B depicts an example screen snapshot of upload history generated by a processing service.

FIG. 14C depicts an example error log generated by a processing service.

FIG. 15 is a block diagram that depicts an example computer system upon which embodiments may be implemented.

### DETAILED DESCRIPTION

In the following description, for the purposes of explanation, numerous specific details are set forth in order to provide a thorough understanding of the embodiments. It will be apparent, however, to one skilled in the art that the embodiments may be practiced without these specific details. In other instances, well-known structures and devices are shown in block diagram form in order to avoid unnecessarily obscuring the embodiments.

I. OVERVIEW

II. SYSTEM ARCHITECTURE

III. GENERATING AUCTION ITEM LISTINGS
A. Introduction
B. Initializing an Auction Item Listing Generating Process
C. Configuring a Client Device
D. Acquiring Item Identification Data and Item Image Data
E. Generating an Auction Item Listing
F. Example of Auction Item Listing
G. Examples of Data Structures
H. Examples of Screen Views Generated by a Processing Service

IV. IMPLEMENTATION MECHANISMS

### I. Overview

An approach is provided for generating an auction item listing. According to the approach, item identification data and item image data is received. The item identification data uniquely identifies an item, and the item image data comprises a digital representation of the item;

Using the item identification data, item attribute data for the item is retrieved. The item attribute data specifies one or more attributes of the item. Based upon both at least a portion of the item attribute data and at least a portion of the item image data, generating of auction listing data is caused on an auction site.

Retrieving item attribute data for the item using the item identification data may comprise generating a request comprising the item identification data, transmitting the request to a lookup database service to cause the lookup database service to compare the item identification data with a plurality of data identification data stored in the lookup database service, and receiving the item attribute data from the lookup database service.

Generating auction listing data at the auction site may be based upon both at least a portion of the item attribute data and at least a portion of the item image data. The generating further comprises transmitting to the auction site at least one or more commands that conform to an application program interface of the auction site and both the at least a portion of the item attribute data and the at least a portion of the item image data.

The auction listing data may be accessible, at the auction site, to a user or a group of users for whom the item identification data and the item image data was acquired.

Receiving item identification data and item image data comprises monitoring any one of: a file transfer protocol (FTP) folder, an electronic mail folder, and a hypertext transfer protocol (HTTP) post. The folders and posts are monitored for data uploaded by a user. Upon detecting that the data is uploaded to the FTP folder, the electronic mail folder, or the HTTP post, the item identification data and the item image data is received from the folder or the post.

The receiving, retrieving and causing are performed by a client device. The client device may include one or more data acquisition components for acquiring the item identification data and the item image data. A data acquisition component may include one or more scanners for acquiring the item identification data, and one or more cameras for acquiring the item image data.

In an embodiment, error handling comprises determining whether receiving the item identification data and the item image data failed, whether retrieving item attribute data failed, or whether generating action listing data failed. In response to determining that any failure has occurred, an error message is generated and transmitted to the auction site. The error message may indicate the problem and provide a description of the failure.

The one or more attributes of the item include one or more of: a title, a description, an identifier, a publication date, a condition, an inventory attribute, a price, a color, a size, a shipping date or a return policy.

### II. System Architecture

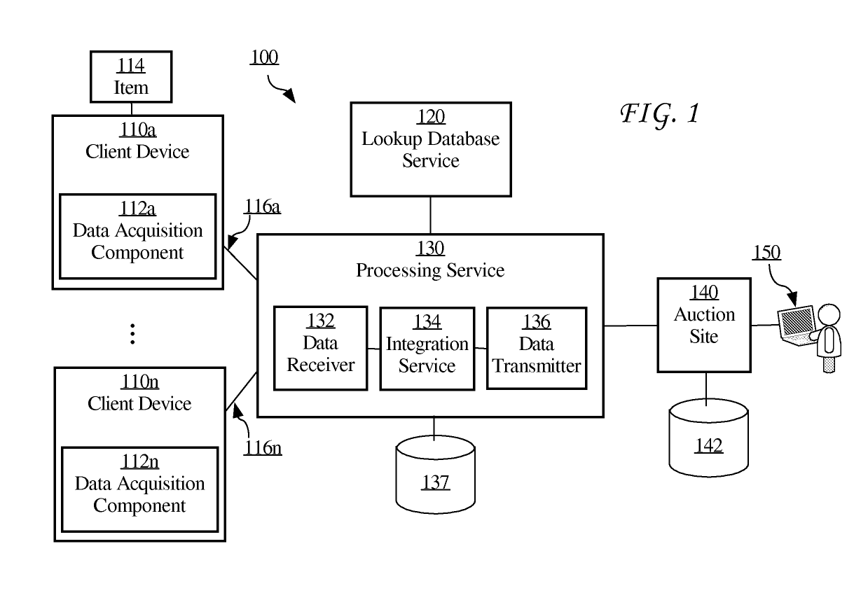

FIG. 1 is a block diagram that depicts an example of an auction item listing generation architecture 100. An auction item listing generation architecture 100 comprises a processing service 130, one or more client devices 110a-110n, and an auction site 140. Optionally, the auction item listing generation architecture 100 also comprises a lookup database service 120.

Client devices 110a-110n are devices configured to perform data acquisition and transmit the acquired data to other devices. Examples of client devices 110a-110n, without limitations, include cameras, scanners, video recorders and other devices configured to acquire data and transmit the acquired data to other devices.

Client devices 110a-110n comprise data acquisition components 112a-112n, respectively. For example, a client device 110a may comprise a data acquisition component 112a, while a client device 110n may comprise a data acquisition component 112n.

Data acquisition components 112a-112n may comprise hardware subcomponents, programmable subcomponents, or both. For example, data acquisition components 112a-112n may include cameras, scanners, memory units and other data storage units, buffers and code instructions for acquiring, storing and transmitting data. Some data acquisition components 112a-112n may include only cameras, other data acquisition components 112a-112n may comprise only scanners, and other data acquisition components 112a-112n may comprise both a camera and a scanner. Thus, data acquisition components 112a-112n may comprise the same or different hardware and subcomponents, programmable subcomponents, or both

Data acquisition components 112a-112n may be configured with Wi-Fi interface and a barcode reader. The Wi-Fi interface may be used to transmit information to and from the data acquisition component 112a-112n. The barcode reader may be used to scan or otherwise acquire a code, such as a point of sale (POS) code displayed on an item.

Data acquisition components 112a-112n may be configured to acquire data from or about an item 114, save the acquired data in a digital data file and transmit the digital data file to another device. For example, data acquisition components 112a-112n may be a digital camera configured to take a picture of an item 114, generate item image data, take a picture of a code identifier depicted on the item 114, generate item identification data, and send the item image data and the item identification data to a processing service 130. A code identifier is a code that uniquely identifies the item. A code identifier may be affixed to or displayed on the item. A code identifier may be represented using a variety of encoding methods. For example, a code identifier may be an item barcode, a quick response (QR) code, or any other code.

According to another example, data acquisition components 112a-112n may comprise both a camera and a scanner. Non-limiting examples of client devices 110a-110n configured with a camera and a scanner include a digital camera device—model G700SE, manufactured by Ricoh Co. Ltd., Cupertino, Calif.

Data acquisition components 112a-112n equipped with a camera and scanner may use the camera to take a picture of an item 114, generate item image data, and transmit the item image data to a processing service 130. Further, the data acquisition component 112a-112n may use the scanner to scan a code identifier depicted on the item 114, generate item identification data, and transmit the item identification data to the processing service 130.

According to other example, data acquisition components 112a-112n of a client device 110a-110n may comprise a scanner, but no camera. For example, data acquisition components 112a-112n may use a scanner to scan an image of an item 114, generate item image data, scan a code identifier depicted on the item 114, generate item identification data, and transmit the data to a processing service 130.

There is no particular order in which a picture of an item 114 and a picture (or an image) of a code identifier of the item 114 are acquired. According to one example, a picture of an item 114 may be taken before a code identifier is scanned. According to another example, a picture of an item 114 may be taken after a code identifier is scanned. Alternatively, a picture of an item 114 may be acquired at the same time that the code identifier for the item 144 is acquired. Similarly, there is no particular order in which the item image data and the item identification data is transmitted. The item image data, may be transmitted to a processing service 130 before, or after, item identification data is sent to the processing service 130.

A processing service 130 may be configured to streamline and simplify the process of generating an auction listing for an item that a user wishes to auction on an online auction site 140. A processing service 130 may be configured to perform the tedious and time consuming tasks for the user. For example, a processing service 130 may be configured to acquire the item attributes for an auction item listing, acquire a picture of the item, upload the attribute data and the picture to the auction site 140, and cause generation of an auction item listing on the auction site 140. Because creating an auction item listing may be a quite challenging task, especially if a user is unfamiliar with the methodology of creating the listing, having the processing service 130 creating the listing for the user simplifies and speeds up the process. Further, acquiring a description of an item and a picture of the item for an auction item listing relieves the user from performing many tedious and time consuming tasks. Moreover, posting the auction item listing on an auction site 140 eliminates the need for the user to become familiar with the intricacies of auction site 140 and the details of posting auction item listings on auction site 140.

A processing service 130 may be configured to receive data, process the data and transmit processed information to an auction site 140. For example, a processing service 130 may be configured to receive, from client devices 110a-110n, item image data and item identification data for an item 114. Based at least on the received data, processing service 130 may determine attributes of an item 114. (Details of determining attributes of an item are provided below.) Based at least in part on the received data and determined attribute data, processing service 130 may cause an auction site 140 to generate an auction item listing for item 114.

A processing service 130 may comprise various hardware and software components. For example, a processing service 130 may comprise a data receiver 132, an integration service 134, a data transmitter 136, and other programmable components.

A data receiver 132 may be configured to receive data from one or more client devices 110a. The data receiver 132 may be configured to receive data using various communication protocols and from various media. For example, the data receiver 132 may receive data using the File Transfer Protocol (FTP), the Telnet Protocol, the Transmission Control Protocol (TCP), the TCP/Internet Protocol (TCP/IP), the Hypertext Transfer Protocol (HTTP), the Simple Mail Transfer Protocol (SMTP), or any other data communications protocol.

A data receiver 132 may be configured to read data from an FTP folder, an email folder, a website, a remote media such as a memory stick, or any other media. For example, a data receiver 132 may retrieve data downloaded by a client device to a FTP folder on a storage device 137, and transmit the retrieved data to an integration service 134. According to another example, a data receiver 132 may be configured to read emails from an email folder on a storage device 137, retrieve an email from the email folder, extract one or more file attachments from the email, and transmit the extracted attachments to an integration service 134.

An integration service 134 may be configured to receive one or more data from a data receiver 132, process the received data and transmit the processed data to an auction site 140. For example, an integration service 134 may receive item image data of an item 114, and item identification data for the item 114, process the data, use the data to determine one or more attributes of the item 114, process the determined attributes, and create a data structure comprising for example, links to the item image data and the attribute data.

In a non-limiting example, an integration service 134 may be configured to receive item image data for a compact disk (CD), which a user would like to auction on an auction site 140. The integration service 134 may process the item image data by resizing or converting the corresponding image to a particular size and format, and creating an auction item image using the converted image. Further, the integration service 134 may receive item identification data containing data indicating a barcode of the CD, use the barcode information to determine attributes of the CD, such as a title of the CD album, a name of the artist, a price of the album, a shipping cost, a delivery date, a return policy information, and other attributes that may be associated with the album. Upon determining the attribute data, the integration service 134 may create a data structure containing hyperlinks to the auction item image data and the attribute data.

An integration service 134 may determine attributes for an item in a variety of ways. For example, an integration service 134 may use code identification data to determine code data of the item, send the code data to a lookup database service 120 and request one or more attributes associated with the code data, and receive, from the lookup database service 134, the attribute data that the lookup database service 134 was able to collect based on the code data. According to another example, an integration service 134 may use data included in the code identification file to determine the code data of the item, and, using the code data as a keyword, perform a content search of the data stored in a storage device 137, to determine attribute data available from the storage device 137.

An integration service 134 may also be configured to receive updates of attribute data for an item. The updates of the attribute data may pertain to the fact that the auctioned item was sold on an auction site 140, that was withdrawn from the site, or that the price was changed. The updates may be received from a user from a user device 150, or may be received from a system administrator accessing a processing service 130. For example, a user, from a user device 150, may wish to change the price of the item that the user is auctioning on an auction site 140. In particular, the user may wish enter a new price for the item, decrease or increase the price, or set a starting price for a potential bidding.

According to another example, a user may wish to set or adjust a quantity of the auctioned items. In particular, if a user is auctioning several copies of the same CD album, upon selling one copy of the CD album, the user may wish to decrease the quantity of the copies that are still available for auctioning.

A data transmitter 136 may be configured to establish communications sessions between a processing service 130 and an auction site 140, and transmit data between the processing service 130 and the auction site 140. A data transmitted 136 may also be configured to facilitate communications between a user device 150 and a processing service 130. For example, a data transmitter 136 may be configured to receive a request from a user device 150 to establish a communications session with a processing service 130, and in response to receiving the request, establish a secure (or non-secure) communications session, and allow the user to access an Application Programming Interface (API) of the auction site 140 from the processing service 130. Furthermore, a data transmitter 136 may be configured to receive update information from the auction site 140 when a particular auction item has been sold or when a price (or other attribute data) of the item has been changed.

An auction site 140 may be configured to provide an Internet-based service for an online auctioning. For example, an auctioning site 140 may be a web server, configured to provide an online auctioning web services over the Internet. An auctioning site 140 may be a web server servicing an online auction and shopping website, which may be used by users and business to buy and sell a broad variety of goods and services. An auctioning site 140 may be managed by consumer-to-consumer companies such as eBay Inc., Amazon Inc., Craigslist Inc., Atomic Mall Inc., Ruby Lane Inc., or any other online auction sites.

An auction site 140 may be configured to display auction item listings for users, and facilitate the bidding and sale of the items described and depicted in the auction item listings. For example, an auction site 140 may be a site operated by eBay Inc., and configured to facilitate online auctioning of items, which user would like to sell and for which auction item listings have been generated and uploaded. If a user wished to auction a particular CD album, and provided a picture of the CD album and code identifier data of the album, then a processing service 130 may create and provide auction item data to the auction site 140, and cause the auction site 140 to generate and display an auction item listing for the user.

A data storage device 142 is communicatively coupled with an auction site 140, and is configured to store data for the auction site 140. For example, a data storage device 142 may be used to store auction item listings, user profiles, credential information for the users and other information that the auction site 140 may utilize.

As briefly described above, a data receiver 132 of a processing service 130 may be configured to receive data from one or more client devices 110a-110n and implement various communications protocols. For example, the data receiver 132 may monitor a FTP folder for data uploaded by a user using FTP. The data receiver 132 may also monitor an electronic mail folder for data sent by a user using for example, SMTP. The data receiver 132 may also monitor a HTTP post for data uploaded by a user. The data receiver 132 may also receive data from client devices 110a-110n using some other data communications method.

In FIG. 1, communications links 116a-116n depict any possible method of communicating data to processing service 130.

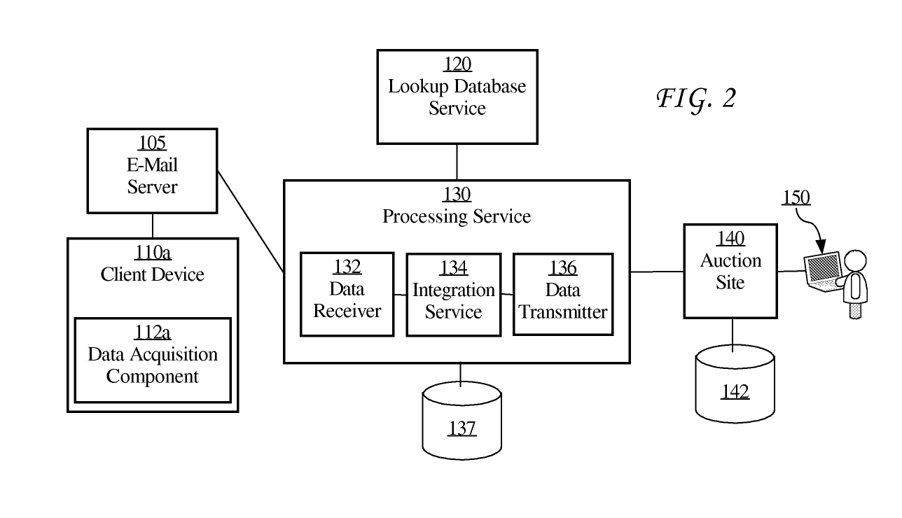

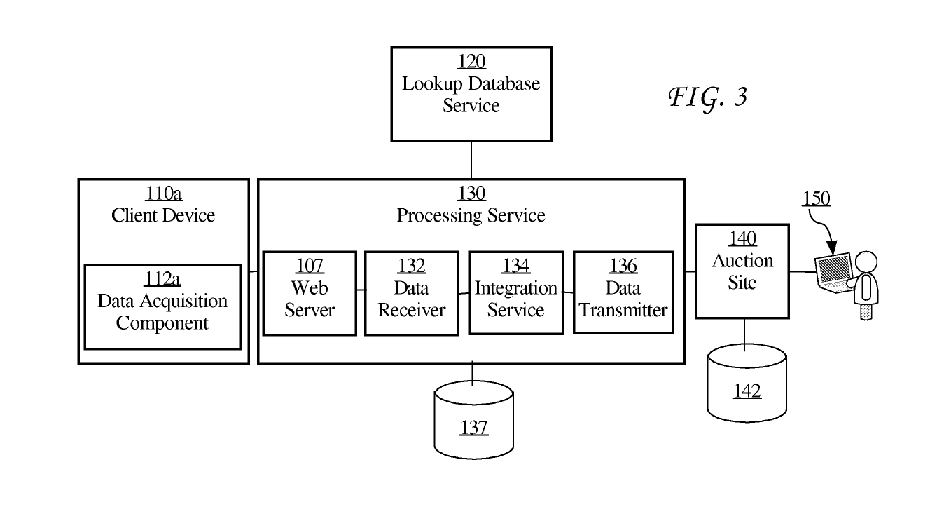

FIGS. 2-3 depict two example methods for communicating item image data and item identification data to a data receiver 132. Briefly, FIG. 2 depicts an embodiment in which a client device 110a communicates item image data and item identification data as email attachments to an electronic mail server using an email protocol, and the email server 105 communicates the email with the attachments to a processing service 130. FIG. 3 depicts an embodiment in which a client device 110a uploads item image data and item identification data as HTTP files to an HTTP server 107 using to a particular Uniform Resource Identifier (URL), and a processing service 130 retrieves the HTTP files from the HTTP server 107. Further details are provided below.

FIG. 2 is a block diagram that depicts an example of an auction item listing generator receiving data from an e-mail server 105. In FIG. 2, a client device 110a, a processing service 130 (comprising a data receiver 132, an integration service 134, a data transmitter 136 and a data storage 137), a lookup database service 120, an auction site 140 and a data storage device 142 correspond to the respective elements depicted and labeled as in FIG. 1. However, unlikely as in FIG. 1, a client device 110a of FIG. 2 does not communicate directly with a processing service 130. Instead, the client device 110a sends item image data and item identification data for a particular item as email attachments to an email server 105, and the email server 105 transmits the email with the attachments to a processing service 130. For example, a client device 110a may be configured to generate an email with attachments containing the item image data and the item identification data, address the email to a processing service email, and send the email with the attachments to the processing service email address via the email server 105. The processing service email address may be made known to the client device 110a by a user or a system administrator in advance.

An email server 105 may be any type of a server configured to provide electronic mail services to clients. For example, an email server 105 may be a server implementing SMTP and facilitating electronic mail communications between a client device 110a and a processing service 130.

Upon receiving an email with attachments containing item image data, item identification data and optionally, other information, an email server 105 may forward the email to an email folder maintained by a processing service 130. The forwarding may be performed in compliance with any known electronic mail communications protocol.

Upon detecting a new email in an email folder, a processing service 130 may retrieve the new email, determine the type of the email, identify attachments of the email and extract the attachments from the email. These steps may be performed by a data receiver 132 of the processing service 130, or any other component of the processing service 130.

A data receiver 132 may parse the received attachments, and identify item image data and item identification data in the attachments. The item image data and the item identification data may be sent as two separate attachments in one email. Alternatively the item image data may be sent as an attachment in one email (or in a body of one email), and the item identification data may be sent as an attachment in another email (or in a body of another email). Furthermore, one or more item image data for an item may be sent along with item identification data. Moreover, one or more item image data for one or more items may be sent along with corresponding one or more item identification data for the items. Various methods of matching the received data with the items are described below.

Once a data receiver 132 identifies item image data and item identification data for a particular item to be auctioned, an integration service 134 may start processing the data as it was described for FIG. 1.

FIG. 3 is a block diagram that depicts an example of an auction item listing generator receiving data from a server 107. Server 107 may be any type of a server configured to provide access to data. For example, server 107 may be an HTTP server that is part of a processing service 130. Server 107 allows a client device 110a to upload HTTP data to the server 107 and allows a processing service 130 to download the HTTP data from the server 107. In FIG. 3, a client device 110a uploads item image data and item identification data as HTTP data to a server 107 using a particular URL, and a processing service 130 retrieves the HTTP data from the server 107. In this example, the server 107 is configured as an HTTP server or at least includes HTTP server capabilities.

In FIG. 3, a client device 110a, a processing service 130 (comprising a data receiver 132, an integration service 134, a data transmitter 136 and a data storage 137), a lookup database service 120, an auction site 140 and a data storage device 142 correspond to the respective elements depicted and labeled as in FIG. 1. However, as in FIG. 1, a client device 110a in FIG. 1 does not communicate directly with a processing service 130. Instead, the client device 110a uploads item image data and item identification data for a particular item to a server, such as a server 107, and a processing service 130 retrieves the data from the server 107. For example, the client device 110a may be configured to upload item image data and item identification data to the server 107 based on the particular URL and a processing service 130 may periodically access the particular URL and check whether any data has been uploaded. If the processing service 130 determines that data has been uploaded to the server 107 at the particular URL, then the processing service 130 may download the data to a storage device 137, associated with the processing service 130. The URL information may be provided to the client device 110a and to the processing service 130 by a user or a system administrator.

Upon determining that item image data, item identification data and optionally, other information, has been uploaded to a server 107, a processing service 130 may download the data to a data storage device 137. Based on the downloaded data, the processing service 130 may identify item image data and item identification data. The steps may be performed by a data receiver 132 of the processing service 130, or any other component of the processing service 130.

A data receiver 132 may parse and process downloaded item image data and item identification data as it is described in FIG. 1.

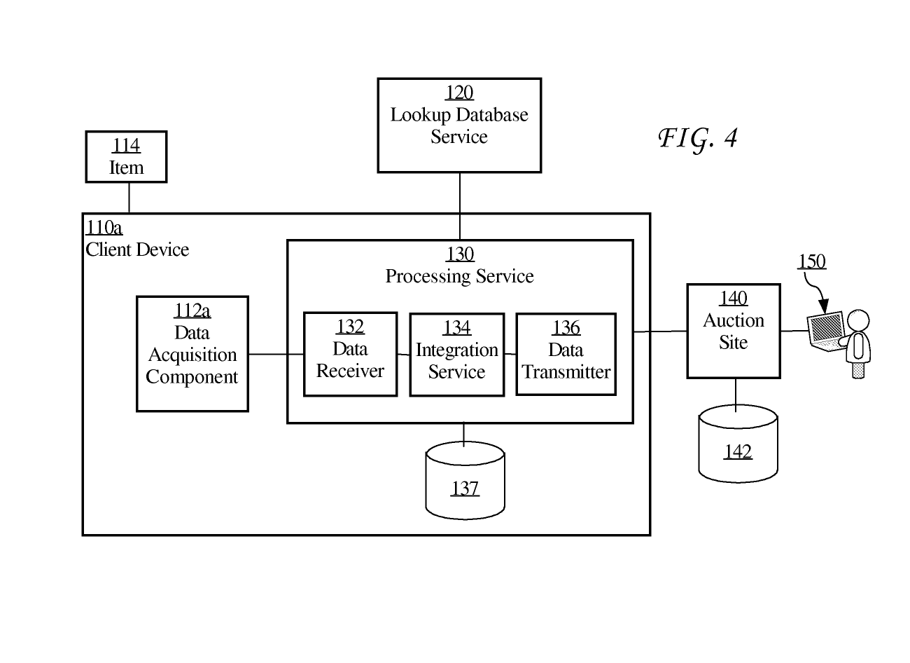

FIG. 4 is a block diagram that depicts an example of an auction item listing generator integrated in a client device 110a. While FIGS. 1-3 depict the embodiments in which each of client devices 110a-110n is separate from a processing service 130, FIG. 4 depicts an embodiment in which a processing service 130 is integrated in a client device 110a.

A client device 110a of FIG. 4 comprises a data acquisition component 112a and a processing service 130. A data acquisition component 112a corresponds to a data acquisition component 112a depicted in FIGS. 1-3. A data acquisition component 112a may comprise hardware subcomponents, programmable subcomponents, or both. For example, a data acquisition component 112a may comprise a camera configured to take a picture of an item 114 and store picture data as item image data. The data acquisition component 112a may also comprise a scanner for scanning a code of the item 114 and storing the scanned data as item identification data. Further, the data acquisition component 112a may be configured to transmit the item image data and the item identification data to a processing service 130, for creating auction item data for the item 114.

The functionalities of a processing service 130, a lookup database service 120, an auction site 140 and respective data storage devices 137 and 142 are described in detail in FIG. 1.

One of the advantages of integrating a processing service 130 in a client device 110a is convenience. For example, integrating a processing service 130 in a client device 110a allows the client device 110a to make item image data and item identification data available to the processing service 130 directly at the client device 110a. This may eliminate the need for transmitting the data from the client device 110a to the processing service 130, and the need for relying on file transfer protocols, email protocols and other protocols for transmitting the data to the processing service 130.

When a processing service 130 is integrated in a client device 110a, item image data and item identification data may be available to a data acquisition component 112a directly at the client device 110a. This may be accomplished by saving the data in memory (not depicted in FIG. 4) of the client device 110a, and allowing the data acquisition component 112a to access the data in the memory. Alternatively, a data acquisition component 112a of a client device 110a may store the data in a data storage unit 137, and a processing service 130 may access the data directly from the data storage 137. As long as the processing service 130 is integrated in the client device 110a, both approaches allow faster transmission of data between the data acquisition component 112a and the processing service 130 compared to if the data is transmitted between the component and the service using FTP, SMTP or any other communications protocol.

In an embodiment, a client device 110a and a processing service 130 are integrated in a digital camera device. An integrated digital camera allows taking a picture of an item 114, scan a code identifier from the item 114, and provide the data directly to a processing service 130. Integrating a processing service 130 in a client device 110a provides convenience and efficiency in generating and uploading auction data to an auctioning site.

### III. Generating Auction Item Listings

### A. Introduction

In an embodiment, a process of generating an auction item listing for an online auction site involves performing several tasks. The majority of tasks are performed without involving a user in the process. In most cases, once a user initializes the components of an auction listing generator and provides a picture and an identifier of the item, the auction listing is generated for the user automatically.

In an embodiment, generating an auction item listing is a simple and straightforward process. It involves very few interactions with a user, and hence, the risk of errors and failures is usually very low. Furthermore, because the user is minimally involved in the process, the user is not expected to be familiar with the details of the listing generation process.

In fact, even initialization of an auction listing generator is straightforward. The initialization usually involves accessing a processing service, authorizing the processing service to access an auction site, and configuring the processing service to receive data from a client device. These tasks are referred to herein as initializing an auction item listing generating process.

Other initialization tasks may include initiating a client device to interact with a processing service and to acquire item image data and item identification data of an item to be auctioned. These tasks are referred to herein as configuring a client device.

Remaining initialization tasks may include taking a picture of an item and scanning a code identifier (such as a barcode or a quick response (QR) code) of the item.

Tasks that are performed for a user and without involving the user in the process include saving picture data as item image data, and transmitting the item image data to a processing service. The tasks may also include saving scanned code identifier data as item identification data, and transmitting the item identification data to the processing service. These tasks are referred to herein as acquiring item identification data and item image data.

Other tasks that do not require user's involvement include using item identification data to retrieve item attribute data for an item and using the item attribute data to cause an auction site to generate an auction item listing for the item. The tasks may also include causing the auction site to attach item image data to the auction item listing and post the auction item listing on the auction site. These tasks are referred to herein as generating an auction item listing.

### B. Initializing an Auction Item Listing Generating Process

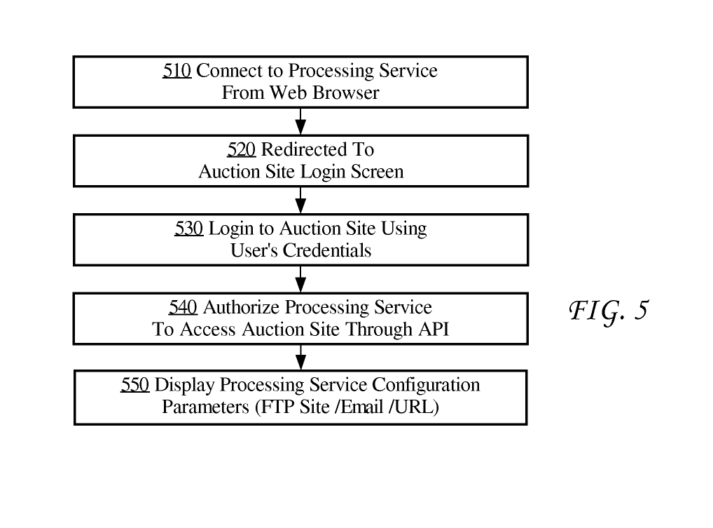

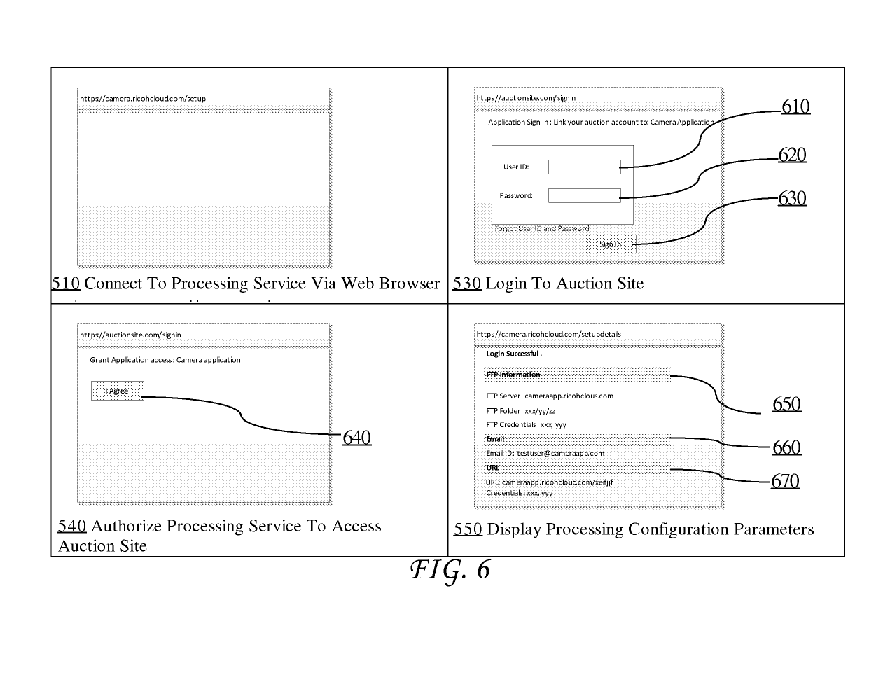

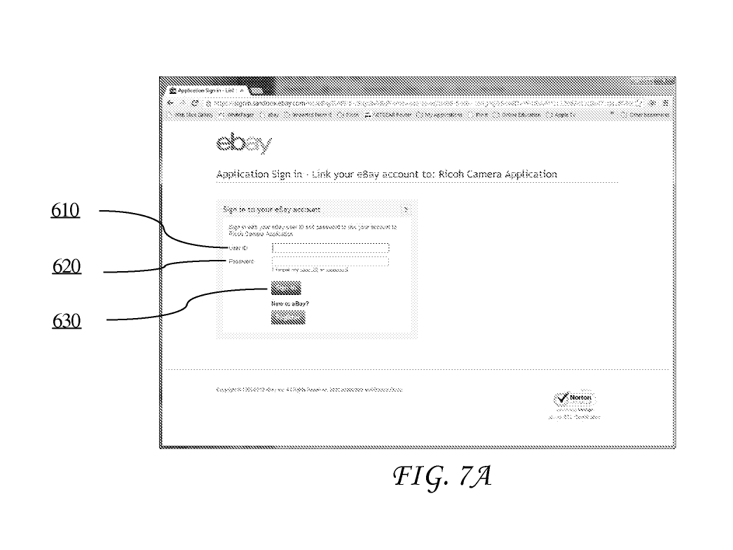

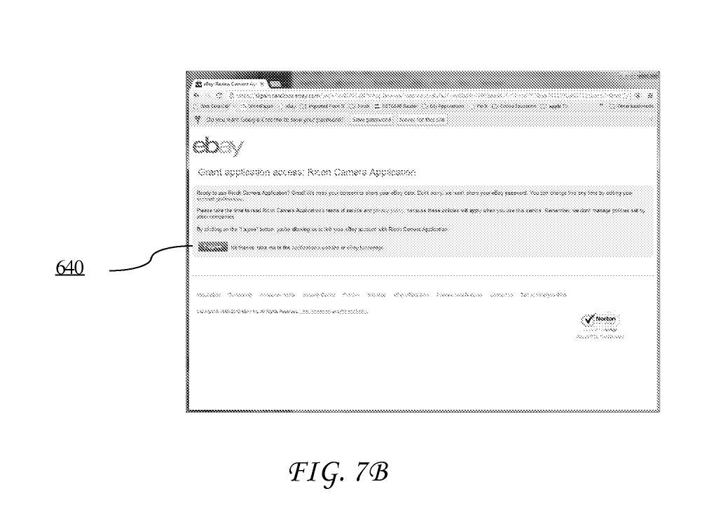

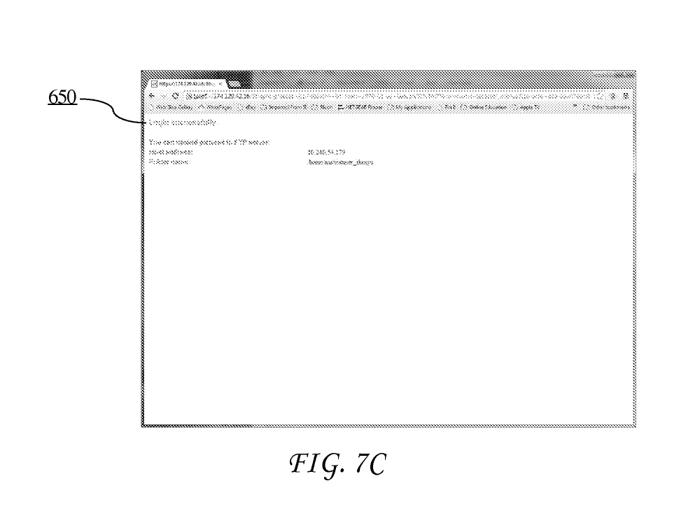

FIG. 5 is a flow diagram that depicts an example of initializing an auction listing generating process, and FIGS. 6-7C depict example screen snapshots of initializing an auction listing generating process.

Referring first to FIG. 5, in step 510, a user connects to a processing service from a web browser application. In this step, the user is trying to access the processing service such as a processing service 130, depicted in FIG. 1. The user may try to access the processing service from any type of device configured to launch a web browser. For example, as depicted in FIG. 1, a user may try to access the processing service from a user device 150. In another embodiment, a user may try to access the processing service from a client device 110a, or any other device that is configured to launch a web browser.

Connecting to a processing service may be accomplished in many ways, one of which is launching a web browser on a user device, as indicated above. For example, a user may launch a web browser on his device and enter a URL address of the processing service. An example of connecting to a processing service is depicted in FIG. 6.

FIG. 6 depicts example screen snapshots of initializing an auction listing generating process. The first quadrant of FIG. 6 depicts a screen snapshot of a web browser page in which a user entered a URL address of “https://camera.ricohcloud.com/setup”. This URL address is just an example of an URL of a processing service. Other processing services may have different URL addresses.

Referring again to FIG. 5, in step 520, a user is redirected from a processing service web page to an auction site login screen. An example of the auction site may be an auction site 140, as depicted in FIG. 1. One of the reasons for redirecting the user from a processing service web page to an auction site login screen is to allow the processing service to access API of the auction site. Once a user accesses the processing service, the user may be redirected from the processing service to the auction site login screen to start the process of granting the processing service access to the API of the auction site.

Upon redirecting a user to an auction site login screen, a login screen of the auction site is displayed by a web browser executed on a user's device. A login screen may be designed in a variety of ways; however, typically, a login screen provides a mechanism for a user to provide user's credentials. For example, a login screen may comprise a login text box, into which a user may enter a user login name, and a user password text box, into which a user may enter a user password.

In step 530, a user is asked to provide valid credentials. The credentials requested in this step include the credentials that would allow the user to access an auction site. Credentials may comprise login information that was provided to the user at the time the user registered with the auction site. For example, the credentials may comprise a user login name and a user password. Examples of logging in to an auction site are provided in FIG. 6 and FIG. 7A.

The second quadrant of FIG. 6 depicts a screen snapshot of logging in to an auction site. In the depicted example, a user is trying to log in to an auction site from a processing service called “Camera Application.” The term “Camera Application” is a non-limiting example of the name of the processing service.

A login screen comprises various graphical elements, widgets, text boxes and selection buttons. In the screen snapshot depicted in the second quadrant of FIG. 6, element 610 indicates a text box into which a user may enter his login name (user ID), element 620 indicates a text box into which the user may enter his password, and element 630 indicates a selection button which the user may select to submit his user ID and password to the auction site.

FIG. 7A depicts an example screen snapshot of a login screen of an auction site. In this non-limiting example, an auction site is a commercial auction site maintained by eBay, Inc. The depicted login screen comprises various graphical elements, widgets, text boxes and selection buttons. In particular, the eBay login screen comprises element 610, which indicates a text box into which a user may enter his login name (user ID), element 620, which indicates a text box into which the user may enter his password, and element 630, which indicates a selection button which the user may select to submit his user ID and password to the auction site.

Referring again to FIG. 5, the user's credentials are validated, and if the validation is successful, then the user may access an auction site, such as an auction site 140 of FIG. 1. The user provided credentials are valid if the user provided exactly the same user login name and user password that were given to the user when the user registered with the auction site.

In step 540, a user is asked upload data to an auction site. The authorization allows the processing service to automatically upload auction item data to the auction site for the auction site to generate an auction item listing and post the listing on the auction site.

A request to authorize a processing service to access an auction site may be made in a variety of ways. For example, a web page generated by the auction site may display a question and a text box, into which a user may enter his answer. Alternatively, a web page generated by the auction site may display a selection button, labeled with a text “I Agree,” which after a user selects, authorizes the processing service to access API of the auction site. Examples of logging in to an auction site are provided in FIG. 6 and FIG. 7B.

The third quadrant of FIG. 6 depicts a screen snapshot of authorizing processing service to access an auction site. In the depicted screen snapshot, a web page generated by an auction site displays a selection button 640. If a user selects the selection button 640, then a user's authorization for the processing service to access the auction site is received by the auction site. Upon receiving the authorization, the processing service would be able to access API of the auction site to upload auction item data to the auction site. In FIG. 6, the processing service is called “Camera Application;” however, the term “Camera Application” is a non-limiting example of the name of the processing service.

FIG. 7B depicts an example screen snapshot of an authorization screen of an auction site. In this non-limiting example, an auction site is a commercial auction site from eBay, Inc. An authorization screen may comprise various graphical elements, widgets, text boxes and selection buttons. In the depicted snapshot, the eBay authorization screen comprises element 640, which indicates a selection button. If a user selects the selection button 640, then a user's authorization for the processing service to access the auction site is received by the auction site. Upon receiving the authorization, the processing service would be able to access API of the auction site to upload auction item data to the auction site. However, if a user fails to authorize the processing service to access the auction site, then the processing service becomes unable to communicate the data to the auction site.

Referring again to FIG. 5, in step 550, a user is redirected back to a processing service, and the processing service displays a web page containing various parameters and settings implemented by the processing service. The parameters and settings may pertain to various methods, using which the processing service may receive data from a client device, such as a client device 110a-110n, depicted in FIG. 1. For example, the web page of the processing service may display information pertaining to an FTP data transfer, an email data transfer, an HTTP data transfer, or any other methods.

The fourth quadrant of FIG. 6 depicts a screen snapshot of an example of a web page displaying various methods for transferring data to a processing service. According to this non-limiting example, a processing service, such as a processing service 130 of FIG. 1, may receive data from a client device via FTP, via an email and via a URL. In particular, the processing service may display parameters and settings for a FTP data transfer to the processing service. For example, element 650 depicts that the processing service may display an FTP server name, an FTP folder name and FTP credentials. Therefore, to upload item image data or item identification data to the processing service, a client device may initiate a FTP data transfer to the FTP server, into the FTP folder.

A processing service may also receive emails. Element 660 indicates an email account identifier of the account configured for the processing service. Therefore, to upload item image data or item identification data to the processing service, a client device may send the data as attachments to an email addressed to the email account indicated by the email account identifier.

A processing service may also retrieve data from an HTTP post. Element 670 indicates a URL address of an HTTP site, to which a client device may post data, and from which the processing device may download the data. Therefore, to upload item image data or item identification data to the processing service, a client device may post the data to the indicated URL address, and the processing service may download the data from the indicated URL address.

FIG. 7C depicts an example screen snapshot of a web page displaying various methods for transferring data to a processing service. The depicted web page indicates that the particular processing service may receive data from a client device using an FTP file transfer. In particular, element 650 indicates that the processing service may display an FTP server name, an FTP folder name and FTP credentials. Therefore, to upload item image data or item identification data to the processing service, a client device may initiate an FTP data transfer to the FTP server, into the FTP folder and by providing the FTP credentials.

In an embodiment, a processing service may be configured to receive data from a client device using other methods, which have not been described above. Similarly, in an embodiment, a client device may be configured to upload the data to a processing service using other methods.

### C. Configuring a Client Device

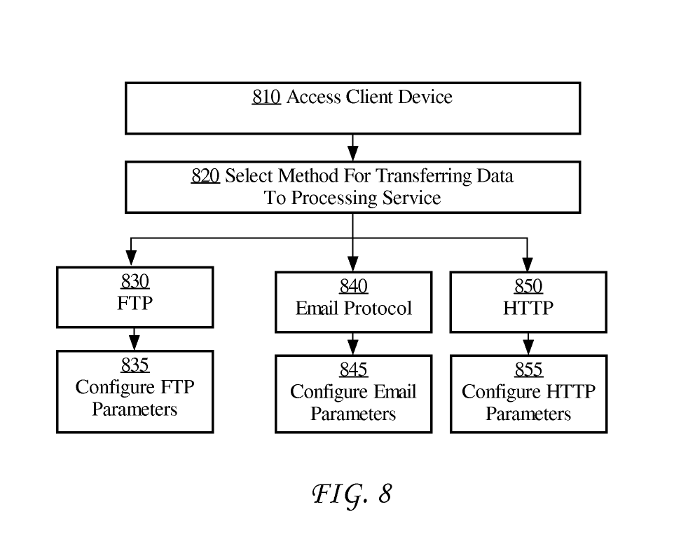

FIG. 8 is a flow diagram that depicts an example configuring of a client device. A client device, such as a client device 110a-110n, may be configured locally or remotely. A client device is configured locally if the device is configured using a graphical user interface (GUI) provided directly on the client device. For example, a client device may be configured by navigating the options provided by a GUI and displayed on the client device. A client device is configured remotely if the client device is accessed remotely from another device, and the client device is configured by remotely navigating the options provided by a software application executed on the client device.

In step 810, a client device is accessed either locally or remotely. If the client device is accessed remotely from another device, then a communications session with the client device is established. In some embodiments, establishing a communications session with the client device may involve determining whether a user may configure the client device remotely. For example, the user may be asked to provide valid credentials, such as a valid user name and a valid password.

Upon a successful authentication of a user to a client device, the user may access a software application executed on the client device and initiate a configuration process of the client device. For example, the user may initiate a software application on the client device that is configured to generate a GUI, which displays configuration options of the client device.

If a client device is accessed locally, then accessing the client device involves executing a software application on the client device that is configured to generate a GUI on the client device, and that displays configuration options of the client device on a display of the client device.

In step 820, a user selects a method for transferring data to a processing service, such as a processing service 130 depicted in FIG. 1. If the client device is accessed locally (i.e., directly), then the user may make a selection using a GUI displayed directly on the client device. However, if the client device is accessed remotely (i.e., from a remote user device), then the user may make a selection using options provided by a software application executed remotely on the client device.

A client device may be programmed to allow one or more methods for transferring data from the client device to a processing service. One method may involve a file transfer of the data from the client device to a data folder maintained by the processing service. For example, a client device may implement FTP, and may allow FTP transfer of item image data and item identification data from the client device to a FTP folder maintained by the processing data.

Another method may involve electronic mail. For example, a client device may be configured to generate an electronic mail, attach one or more attachments to the email and transmit the email with the attachments to a recipient email account configured on a processing service. In this example, an identifier of the recipient email account may be an email address of the processing service. Transferring the data from the client device to the processing service may be performed by implementing any type of email protocol, such as SMTP.

Other method may involve uploading an HTTP file to a website maintained by a server. According to this method, item image data and item identification data may be uploaded to an HTTP post, maintained by an HTTP server, and identified by a particular URL. For example, item identification data and item image data may be uploaded using the particular URL to the HTTP server, and made available to a processing server at the particular URL.

In an embodiment, a client device is configured to support each and every data transfer method described above. In another embodiment, a client device is configured to support not only the methods described above, but also additional method not described so far. In yet other embodiments, a client device is configured to support one or two methods described above.

If in step 830 a determination is made that a client device implements FTP, then in step 835 the client device is configured to transfer data to a FTP folder maintained by a processing service. The client device may be provided with an FTP address of the FTP folder maintained by the processing service, and enabled to handle FTP data transfer.

If in step 840 a determination is made that a client device implements an email protocol, such as SMTP, then in step 845, the client device is configured to use emails and email attachments to send data to a processing service. The client device may be provided with a processing service email address, provides with a client device email address, and enabled to create emails, include attachments to the emails, and send emails from the sender email address to the recipient email address.

If in step 850 a determination is made that a client device implements HTTP, then in step 855, the client device is configured to use HTTP to post data to an HTTP server. The client device may be provided with a particular URL address of a particular HTTP server, and configured to post item image data and item identification data to the particular URL.

Although not depicted in FIG. 8, a client device may also be configured to implement other methods of transferring data directly or indirectly to a processing service. For example, a client device may be configured to transfer the data using Telnet, TCP/IP or other communications protocol.

Once a client device is configured to transfer data from the client device to a processing service, the client device may be used to communicate item image data and item identification data to the processing service.

### D. Acquiring Item Identification Data and Item Image Data

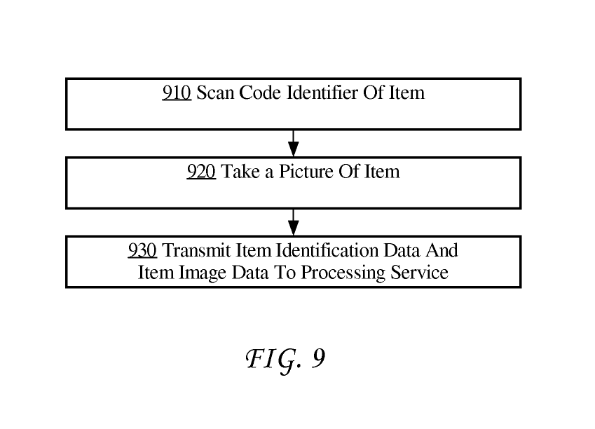

FIG. 9 is a flow diagram that depicts an example acquiring of item identification data and item image data by a client device. A client device may be any client device 110a-110n, as described in FIG. 1. For example, a client device may be configured with a camera for taking a picture of an item, and a scanner for scanning a code identifier displayed on the item. According to another example, a client device may be configured only with a camera (and use the camera to take both a picture of the item and a picture of a barcode), or configured only with a scanner (and use the scanner to scan the item and the barcode; this may be practical if the item is for example, a pair of tickets to a football game).

In step 910, using a client device, a user scans (or takes a picture of) a code identifier of an item to be auctioned. A code identifier is a code that uniquely identifies the item. Usually, a code identifier is affixed to or displayed on the item or the item packaging. For example, a code identifier may be a barcode displayed on the item packaging, a QR code displayed on the item, or any other code by which the item may be identified. Non-limiting examples of other codes include EZcode, high capacity color barcode, maxi code, stacked barcode, Aztec code, shot code, matrix code, and SPARQ code.

If a user scans a code identifier, then, upon finishing the scanning, a scanning component of the client device generates item identification data. The item identification data may be represented in any of many data formats. For example, the item identification data may be represented in PDF format, JPEG format, or any other format. The resulting item identification data represents the code identifier.

If a user takes a picture of a code identifier, then, once the picture is taken, the picture data may be converted to the data format in which item identification data would have been represented if the code identifier was scanned. For example, if scanning the code identifier would have resulted in generating item identification data represented in PDF format, then the picture data taken using a camera may be converted to PDF format. Other methods of acquiring the item identification data may also be implemented.

In step 920, using a client device, a user takes a picture of (or scans) an item to be auctioned. While taking a picture of the item may be a more intuitive approach for acquiring data representing the item, scanning the item may also be implemented. If the item to be auctioned is a laptop or a sofa, then it may be more practical to take a picture of the item than to scan the item. However, if the item to be auctioned is a pair of tickets to a football game or a ski lift pass, then it may be more practical to scan the item than to take a picture of the item.

If a user takes a picture of an item to be auctioned, then once the picture is taken, the picture data may be referred to as item image data. The item image data may be represented in any of many data formats. For example, the item image data may be represented in JPEG format, TIFF format, BW format, or any other format.

If a user scans an item to be auctioned, then, upon finishing the scanning, a scanning component of the client device generates scanned data, which may be converted to item image data. Depending on the preferred data format for the item image data, the scanned data of the item may be converted to JPEG format, TIFF format, BW format, or any other format.

In an embodiment, a user may use two separate devices to acquire item image data and item identification data of an item to be auctioned. For example, a user may use a camera to acquire item image data, and a scanner to acquire item identification data. Both devices (a camera and a scanner) may be interfaced with a processing service by configuring the processing service to pair item identification data and item image data based on a user identifier even if the data is provided by separate client devices. For example, if a user uses a camera to take a picture of an item, the corresponding item image data may have an associated user identifier. The same user identifier may be associated with item identification data acquired by the user using a scanner.

In step 930, item identification data and item image data is transmitted to a processing service. For example, if the processing service is configured to receive FTP file transfers from a client device, and the FTP server, FTP folder and credentials have been provided to the client device, then the item identification data and the item image data may be transferred to the FTP folder maintained by the processing service. The various methods of configuring a client device to transfer item identification data and item image data to a processing service were described in FIG. 8.

Item identification data and item image data may be acquired by one client device or by more than one client devices. Further, item identification data may be transferred to a processing service before, or after, item image data is transferred to the processing service.

In an embodiment, item identification data, but not item image data, is provided to a processing service. For example, a user may be able to scan a code identifier of an item, but may be unable to take a picture of the item. According to another example, a user may be able to scan a code identifier and take a picture of the item, but item image data may be corrupted, and thus unavailable for transferring to the processing service.

In an embodiment, item image data, but not item identification data, is provided to a processing service. For example, a user may be able to take a picture of an item, but may be unable to scan a code identifier of the item. This may happen when the user does not have a scanner, or the scanner does not work. In this case, the user may transfer only the item image data to the processing service.

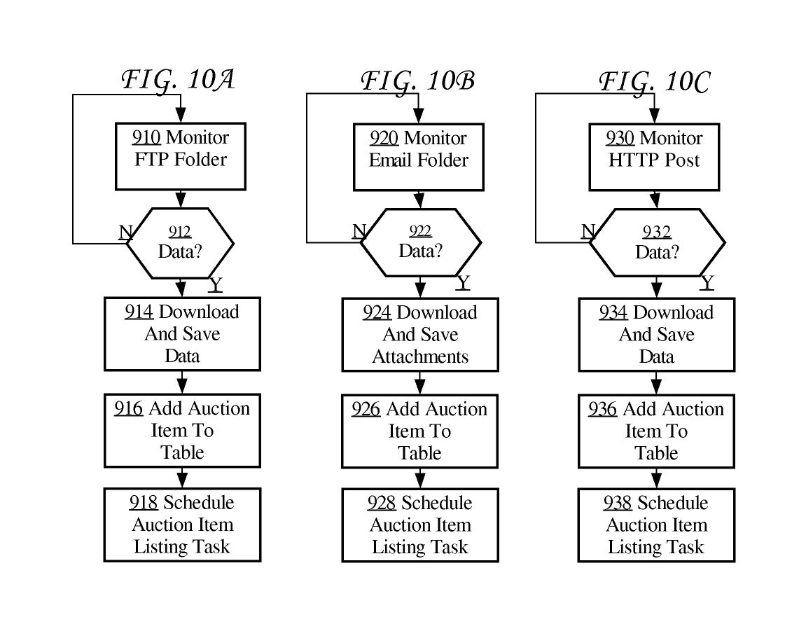

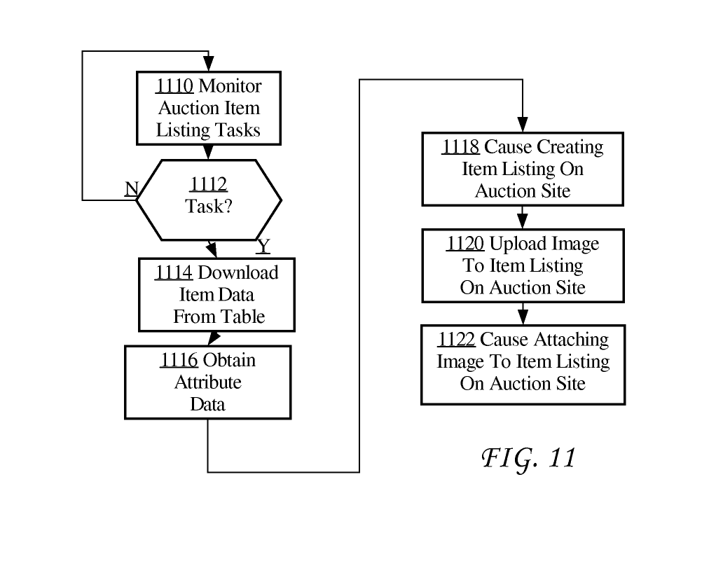

FIGS. 10A-10B are flow diagrams that depict various approaches for acquiring data by a processing service. For the purpose of illustrating the approaches depicted in FIGS. 10A-10C, an assumption is made that item image data and item identification data has been transferred or uploaded by a client device.

FIG. 10A is a flow diagram that depicts an approach for acquiring item identification data and item image data by a processing service from a file transfer folder. In step 910, a processing service monitors an FTP folder configured on a disk (or any other storage device) accessible to the processing service. If in step 912, the processing service determines that data is present in the FTP folder, then in step 914, the processing service downloads the data, and optionally, saves the data on a disk or other storage device accessible to the processing service.

Downloaded data may comprise item identification data, item image data, or both. For example, a user may have uploaded, to an FTP folder, item identification data representing a code identifier of an item to be auctioned, and item image data representing one or more pictures of the item. According to another example, a user may have uploaded, to an FTP folder, only item identification data of a code identifier of an item. According to other example, a user may have uploaded item identification data of a code identifier of an item and item image data representing one picture of the item.

In an embodiment, a processing service processes item image data. The processing may include changing a data format of the item image data. The processing may also include converting, resizing or otherwise processing the item image data to meet a picture specifications set forth by an auction site.

In step 916, a processing service creates auction item data. Auction item data may comprise image data, item identification data, or both. Links to auction item data may be stored in data structure such as a data table, a data array or any other data container, configured to organize and store data. The data structure may be indexed by a user identifier, a user identifier a date, a user device identifier, or any other way that uniquely identifies items that the user would like to auction. For example, if a processing service downloaded item image data that was uploaded by a particular user, then the processing service may determine a particular user identifier, associated with the particular user, and use the particular user identifier to determine whether any entry for the particular user identifier has been created in the data structure. If such an entry has not been created, then the processing service may create an entry for the particular user identifier in the data structure, and add a link to the item image data to the data structure in that entry.

However, if the processing service determines that an entry for the particular user has been already created in the data structure, and the entry has not been yet used to generate an auction item listing, then the processing service may add a link to the item image data to the entry in the data structure. For example, if the entry for the particular user comprised item identification data, then, upon downloading the item image data for the same user, the processing service may add the link to the downloaded item image data to the entry in the data structure.

In step 918, a processing service schedules auction item listing tasks for an auction item. In this step, the processing service determines whether at least item identification data or item image data for an item to be auctioned has been received for the item, and if so, schedules the auction item data to be uploaded to an auction site.

FIG. 10B is a flow diagram that depicts an approach for acquiring item identification data and item image data by a processing service from an email folder. In step 920, a processing service monitors an email folder configured on a disk (or any other storage device) accessible to the processing service. If in step 922, the processing service determines that an email has been received in the email folder, then in step 924, the processing service reads the email, and determines whether item data is included in a body of the email or in the attachments. If the item data is included in a body of the email, then the processing service extracts the data from the body of the email, and optionally, saves the data on a disk or other storage device accessible to the processing service. If the item data is included as attachments to the email, then the processing service reads the attachments, extracts the item data from the attachments, and optionally, saves the data on a disk or other storage device.

Extracted data may comprise item identification data, item image data, or both. Various scenarios in which different types of data are extracted were described in step 914.

Steps 926 and 928 of FIG. 10B correspond to respective steps 916 and 918 of FIG. 10A.

FIG. 10C is a flow diagram that depicts an approach for acquiring item identification data and item image data by a processing service from a post. In step 930, a processing service monitors an HTTP post configured on a server accessible to the processing service. An HTTP post may be indicated by a URL address of a web page maintained by an HTTP server, which is accessible to both a client device and the processing service.

If in step 932, the processing service determines that data has been posted at a particular URL, then in step 934, the processing service downloads the data, and optionally, saves the data on a disk or other storage device accessible to the processing service.

Downloaded data may comprise item identification data, item image data, or both. Various scenarios in which different types of data are extracted were described in step 914.

Steps 936 and 938 of FIG. 10B correspond to respective steps 916 and 918 of FIG. 10A.

### E. Generating an Auction Item Listing

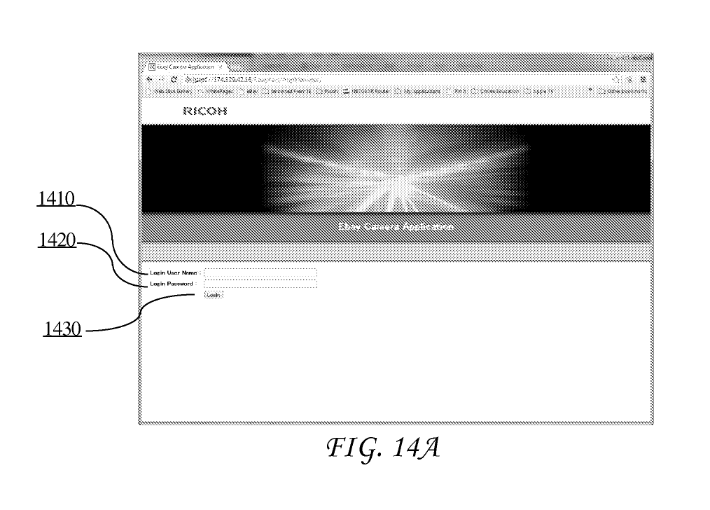

FIG. 11 is a flow diagram that depicts an example process of generating an auction item listing. In step 1110, a processing service monitors auction item listing tasks. An auction item listing task is a task for which at least item image data or item identification data (or both) has been received, and which has been scheduled to cause an auction site to generate an auction item listing. Auction item listing tasks may be stored in a data structure maintained by or accessible to the processing service. Non-limiting examples of the data structures for storing the tasks include data tables, data arrays, data queues, or any other data structures configured to store data, and are depicted in FIG. 13.

If in step 1112 a processing service determines that an auction item listing task has been scheduled, then, in step 1114, the processing service downloads item data using the links to item image data, or item identification data, or both. The links may have been stored in a table, as described in step 916 of FIG. 10A. The table may be indexed by a user identifier, a user device identifier or using any other identifier. The table may comprise entries which contain links to item image data and item identification data. For example, if a user provided item identification data representing a code identifier of an item, and provided item image data representing a picture of the item, then the table may comprise at least one entry, and the entry may be used to store a link to the item identification data and a link to the item image data.

In step 1116, a processing service obtains attribute data for an item to be auctioned. Attribute data is data that provides description and additional information about the item. For example, attribute data for an item may comprise a name of the item, a price, a description or specification of the item, a description of shipment policy for delivering the item to a buyer, a description of return policy if the item needs to be returned, a condition of the item, a quantity of the item, and other types of information.

The types of attribute data depend on the type of the item to be auctioned. For example, if the item is an electronic device such as a switch, then the attribute data for the switch may include a name of the switch, a name of the switch manufacturer, a specification of the switch, a description of the condition of the switch, whether the switch is available for an online purchase, a price of the switch, and whether a tax will be added to the price.

Attribute data for an item may be stored in a variety of formats and in a variety of data structures. For example, attribute data may be stored in an HTML document. Non-limiting example of an HTML document containing attribute data for a NET GEAR switch is included below.

<entry>
<barcode>16162537512161679960</barcode>
<published>2012-07-05T10:37:12.000Z</published>
<updated>2012-10-18T10:37:02.000Z</updated>
<title>Switch 8-port 10/100mbps</title>
<content type=“text”>
The NET GEAR FS100 series of fast Ethernet switches brings the 100Mbps switching
technology in a compact form factor to the small office marketplace at an aggressive
price. These switches are designed to deliver improved performance of the most
demanding multimedia and image processing applications. Switch 8-Port 10/100MBPS
</content>
<condition>new</condition>
<inventories>
<inventory channel=“online” availability=“in Stock”>
<price tax=“0.0” shipping=“0.0” currency=“USD”>55.0</price>
</inventory>
</inventories>
</entry>

In the above example, attribute data is represented in an HTML document. In the example HTML document, individual attribute names and attribute values are separated by delimiters. The HTML data includes a barcode attribute, which may correspond to an item identification data of an item. The barcode attribute is one of many attributes that may be used to identify the attribute data for the item to be auctioned. The attribute data also include a name of the switch, a name of the switch manufacturer, a specification of the switch, a description of the condition of the switch, whether the switch is available online, a price of the switch, and whether a tax will be added to the price. The above example is one of many possible representations of the attribute data for an electronic switch.

Attribute data may be generated by a system administrator or a user of a processing service. For example, a system administrator may generate a library of attribute data indexed by barcodes of the items. The library may be modified and updated by the system administrator (or a user) when the new items and attributes are added to the library, or when the information needs to be modified.

A library of attribute data may be stored locally in a storage device 137, as depicted in FIG. 1, and made accessible to a processing service. Alternatively, a library of attribute data may be stored remotely and may be managed by a lookup database service, as a lookup database service 120 depicted in FIG. 1.

If a library of attribute data is managed by a lookup database service, then a processing service may obtain attribute data for an item to be auctioned by sending a request to the lookup database service. The request may contain item identification data for the item. Upon receiving the item identification data, the lookup database service may search the library of attribute data until particular attribute data, associated with the item identification data, is found, and send the particular attribute data to the processing service. In response to sending the request, the processing service may obtain the attribute data from the lookup database service.

In step 1118, a processing service causes creating of an auction item listing on an auction site. Causing an auction item listing may involve accessing an API of the auction site, and using the functionalities of the API to upload attribute data to the auction site and cause the auction site to generate the listing. It may cause an auction site to allocate some storage space in a storage device associated with the auction site, create an auction listing template, input at least some of the attribute data into the template, and generate the auction item listing.

In step 1120, a processing service uploads item image data to an auction site. This step may be performed if the item image data for the item is available. For example, if a user has not uploaded the item image data for the item, then this step may be omitted. According to another example, if a user has uploaded item image data representing two or more pictures of the item, then the image data representing all the pictures for the item may be uploaded to the auction site

Uploading item image data to an auction site may involve accessing API of the auction site, and using the functionalities of the API to deliver the item image data to the auction site.

Once item image data is uploaded to an auction site, in step 1122, a processing service causes an auction site to attach the item image data to an auction item listing. This may be accomplished using the functionalities of the auction site's API.

An auction item listing for an item may be created using all attribute data and all item image data available for the item. Alternatively, an auction item listing may be created using some, but not all, attribute data and image data available for the item. For example, in some implementation, an auction item listing may be defined using one or more levels of details. In a first level of detail, an auction item listing may comprise a name of the item and a picture of the item. Creating this level of detail of the auction item listing involves using some attribute data and item image data available for the item.

In a second level of detail, an auction item listing may comprise all available information for the item, including all available pictures and information of the item. Creating this level of detail of the auction item listing involves using all attribute data and item image data available for the item.

Once step 1122 is completed, an auction item listing is available for displaying and viewing on an auction site.

An auction item listing may be made available on an auction site to a user who provided item image data, or item identification data (or both). Alternatively, an auction item listing may be made available on an auction site to a group of users. The type of access to an auction item listing may be determined based on the user privileges. For example, an auction item listing may be made available for editing and viewing to the user who provided item image data or item identification data; however, it may be made available only for viewing to other users who access to the auction site.

An auction item listing may be modified if a user determines that some of the attributes of the item has changed. For example, the auction item listing may be modified is a user changes a price of the item, changes a quantity of the item, changes a description of the item, or determines that some other changes may be made to the listing. The changes may be performed by using an API available at the auction site, or by accessing a processing service and requesting modifications to the listing.

An auction item listing may also be modified during auctioning of the item. For example, if the auctioned item has been sold, then an auctioning site may remove the auction item listing from the database. According to another example, if bids have been received for the auctioned item, then the price attribute included in the auction item listing may be updated by the auction site. According to other example, if a quantity of the auctioned item is reduced due to a sale of the item, then the quantity attribute included in the auction item listing may be updated by the auction site.

However, in some circumstances, the process of generating an auction item listing may be unsuccessful. There may be many reasons for the process failure. For example, uploading item data may fail, or accessing an auction site may fail. In such circumstances, information about the failure may be generated and distributed to the users or the auction site.

In an embodiment, a processing service determines whether receiving the item identification data and the item image data was unsuccessful, whether retrieving item attribute data was unsuccessful, or whether generating action listing data was unsuccessful. In response to determining that any of the above failures was detected, the processing service may generate an error message indicating one or more problems. The error message may be transmitted to the auction site or to a user for whom generating an auction item listing has failed. The error message may indicate the type of the error, the reason for the failure and the item data that processing was unsuccessful.

### F. Example of Auction Item Listing

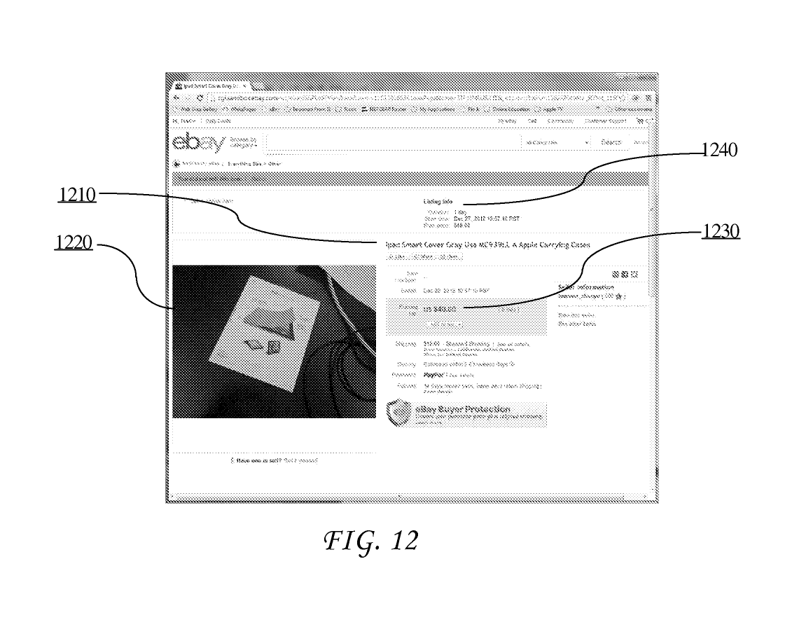

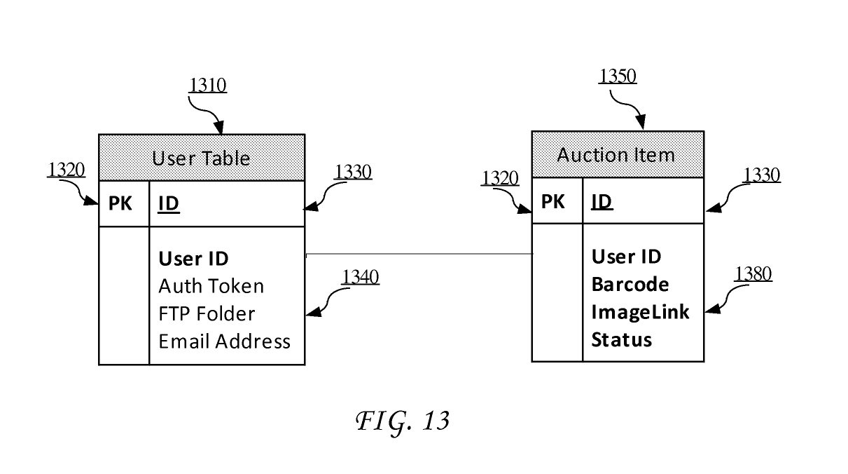

FIG. 12 depicts an example of an auction item listing displayed on an auction site. This particular example of an auction item listing was generated for a computer mouse device, and has been posted on an eBay auction site. In a header 1210, an auction item listing provides a name of the device (“Doggles Goggles Xsmall” mouse device), a weight of the device, and a color of the device. Below the header, the auction item listing provides various selectable buttons, such as “Like,” and others. Below the selectable buttons, the listing provides a starting bid amount 1230, shipping cost information, estimated delivery date, a description of the form of payment, and a description of the return police. On the right site, the listing provides a picture 1220 of the device. Above the header, the listing provides the posting “Living” information 1240, which indicates duration of the auctioning term for the device, an auctioning start time, and an auctioning start price.

The example depicted in FIG. 12 is provided to illustrate one or many ways of implementing an auction item listing. Other auction sites may implement other types of auction item listings and may provide different types of information about the auctioned items.

### G. Examples of Data Structures

FIG. 13 depicts examples of data structures used by a processing service. In various embodiments, a processing service may use a variety of data structures for storing information about items to be auctioned. The examples of data structures depicted in FIG. 13 are not to be viewed as limiting in any way.

In FIG. 13, two data structures are depicted. One data structure is called a user table 1310, and another data structure is called an auction item 1350. Depending on the implementation, a processing service may use the data structures 1310 and 1350, or may use some other structures not depicted in FIG. 13.

A user table 1310 is used to store information about a user for whom an auction item listing may be generated. User table 1310 may be indexed by a user identifier, a user device identifier or any other key or identifier. In FIG. 13, user table 1310 is indexed by a primary key (PK) 1320 associated with a user. A value of the PK 1320 is indicated by an identifier (ID) 1330. User table 1310 may store data for one or more users, and thus, user table 1310 may have many entries, each identified by a unique ID 1330.

For each user, user table 1310 may store various types of information 1340. For example, the stored information 1340 may comprise a user ID, a user authentication token, an FTP folder name, an email address, and other data.

An auction item data structure 1350 is used to store information about an item for which an auction item listing may be generated. Auction item data structure 1350 may be indexed by a primary key (PK) 1320, which may correspond to the same PK 1320 in user table 1310. A value of the PK 1320 is indicated as an identifier (ID) 1330, which may correspond to the same ID 1330 in user table 1310.

For each ID 1330, auction item data structure 1350 may store various types of information 1380. For example, the stored information 1380 may comprise a user ID, a barcode of the item, a link to item image data for the item, and a status of the auction item listing. A status of the auction item listing may indicate whether some or all information pertaining to the item has been received or obtained, whether some information is missing, or whether generating of an auction item listing for the item has been scheduled.

### H. Examples of Screen Views Generated by a Processing Service

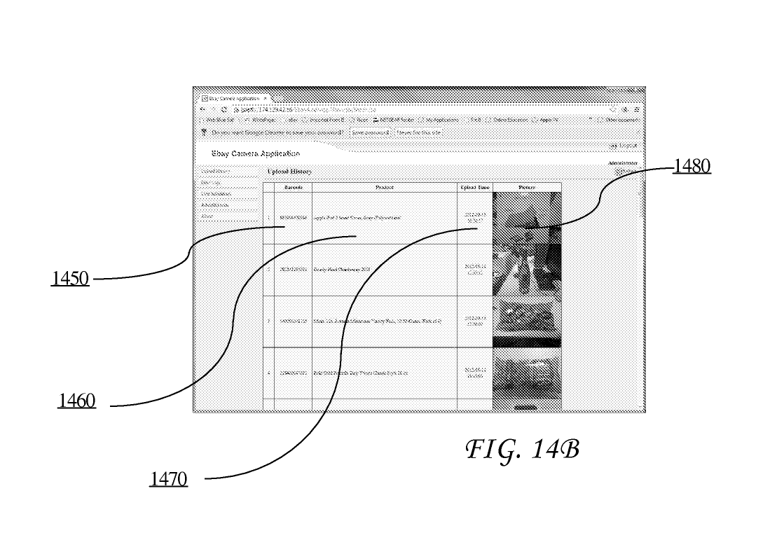

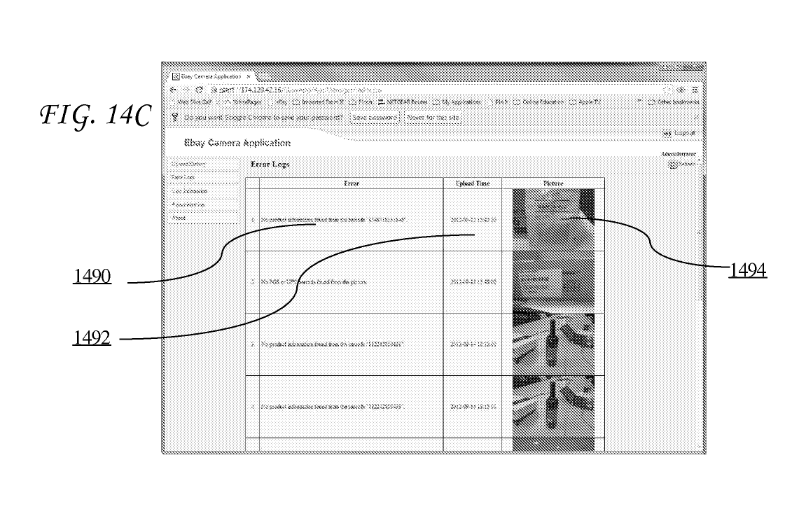

FIGS. 14A-14C depict various examples of screen snapshots generated by a processing service. The examples depicted in FIGS. 141A-14C are to be viewed as non-limiting examples and may depend on the implementation of the processing service.

FIG. 14A depicts an example login screen view generated by a processing service. The example login screen view was generated by a processing service, proprietary of Ricoh Co., Ltd. The login screen view depicts a portal to the processing service. Using the portal, a user may access the processing service. For example, after a user provides a user login name 1410 and a user password 1420, and selects a login button 1430, the user may be granted access to the processing service.

FIG. 14B depicts an example screen snapshot of upload history generated by a processing service. This example depicts a table having several rows and several columns. The rows are numbered and each row contains information pertaining to an individual item. For example, for the first item (depicted in the first row of the table), the table includes barcode information 1450, a product name 1460, an upload time 1470, and a picture 1480 of the item. In other implementations, the table may provide additional information pertaining to the items.

FIG. 14C depicts an example error log generated by a processing service. This example depicts a table having several rows and several columns. The rows are numbered and each row contains information pertaining to an individual error detected by the processing service. For example, for the first error (depicted in the first row of the table), the table includes an error description 1490, an upload time 1492, and a picture 1494 during which the error occurred. In other implementations, the table may provide additional information pertaining to the errors detected by the processing service.

In an embodiment, a process for preparing and uploading an auction item listing to an auction site is simplified and performed with minimal involvement of a user. The process of generating auction item listing does not require a user to know how to create an auction item listing, how to describe the item, how to price the item, or how to describe shipment policy or return policy for the item. Moreover, the user does not need to know how to incorporate a picture of the item into the auction item listing. All these steps are automatically performed for a user.

### IV. Implementation Mechanisms

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

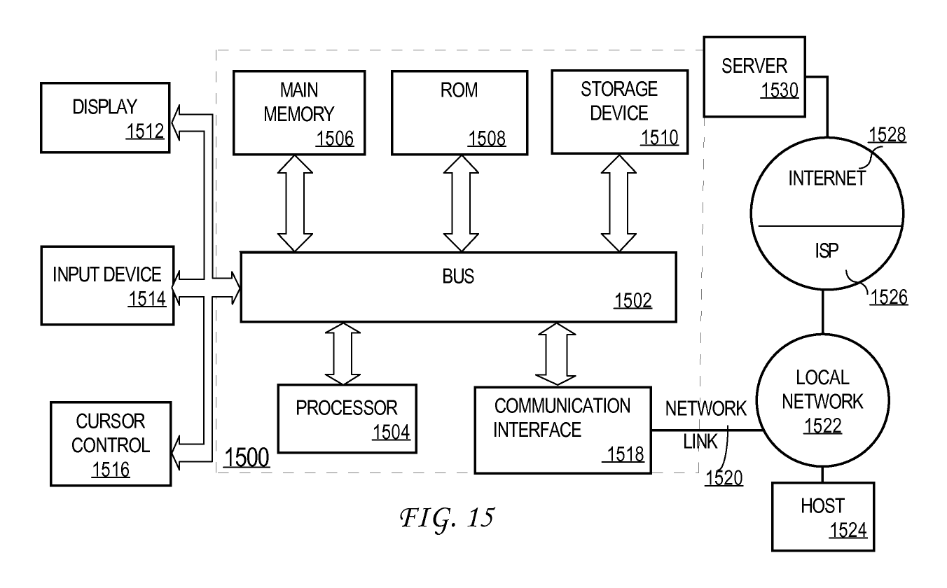

For example, FIG. 15 is a block diagram that illustrates a computer system 1500 upon which an embodiment of the invention may be implemented. Computer system 1500 includes a bus 1502 or other communication mechanism for communicating information, and a hardware processor 1504 coupled with bus 1502 for processing information. Hardware processor 1504 may be, for example, a general purpose microprocessor.

Computer system 1500 also includes a main memory 1506, such as a random access memory (RAM) or other dynamic storage device, coupled to bus 1502 for storing information and instructions to be executed by processor 1504. Main memory 1506 also may be used for storing temporary variables or other intermediate information during execution of instructions to be executed by processor 1504. Such instructions, when stored in non-transitory storage media accessible to processor 1504, render computer system 1500 into a special-purpose machine that is customized to perform the operations specified in the instructions.

Computer system 1500 further includes a read only memory (ROM) 1508 or other static storage device coupled to bus 1502 for storing static information and instructions for processor 1504. A storage device 1510, such as a magnetic disk or optical disk, is provided and coupled to bus 1502 for storing information and instructions.

Computer system 1500 may be coupled via bus 1502 to a display 1512, such as a cathode ray tube (CRT), for displaying information to a computer user. An input device 1514, including alphanumeric and other keys, is coupled to bus 1502 for communicating information and command selections to processor 1504. Another type of user input device is cursor control 1516, such as a mouse, a trackball, or cursor direction keys for communicating direction information and command selections to processor 1504 and for controlling cursor movement on display 1512. This input device typically has two degrees of freedom in two axes, a first axis (e.g., x) and a second axis (e.g., y), that allows the device to specify positions in a plane.

Computer system 1500 may implement the techniques described herein using customized hard-wired logic, one or more ASICs or FPGAs, firmware and/or program logic which in combination with the computer system causes or programs computer system 1500 to be a special-purpose machine. According to one embodiment, the techniques herein are performed by computer system 1500 in response to processor 1504 executing one or more sequences of one or more instructions contained in main memory 1506. Such instructions may be read into main memory 1506 from another storage medium, such as storage device 1510. Execution of the sequences of instructions contained in main memory 1506 causes processor 1504 to perform the process steps described herein. In alternative embodiments, hard-wired circuitry may be used in place of or in combination with software instructions to implement embodiments described herein. Thus, embodiments are not limited to any specific combination of hardware circuitry and software.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 1510. Volatile media includes dynamic memory, such as main memory 1506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1502. Transmission media can also take the form of acoustic or light waves, such as those generated during radio-wave and infra-red data communications.

Various forms of media may be involved in carrying one or more sequences of one or more instructions to processor 1504 for execution. For example, the instructions may initially be carried on a magnetic disk or solid state drive of a remote computer. The remote computer can load the instructions into its dynamic memory and send the instructions over a telephone line using a modem. A modem local to computer system 1500 can receive the data on the telephone line and use an infra-red transmitter to convert the data to an infra-red signal. An infra-red detector can receive the data carried in the infra-red signal and appropriate circuitry can place the data on bus 1502. Bus 1502 carries the data to main memory 1506, from which processor 1504 retrieves and executes the instructions. The instructions received by main memory 1506 may optionally be stored on storage device 1510 either before or after execution by processor 1504.

Computer system 1500 also includes a communication interface 1518 coupled to bus 1502. Communication interface 1518 provides a two-way data communication coupling to a network link 1520 that is connected to a local network 1522. For example, communication interface 1518 may be an integrated services digital network (ISDN) card, cable modem, satellite modem, or a modem to provide a data communication connection to a corresponding type of telephone line. As another example, communication interface 1518 may be a local area network (LAN) card to provide a data communication connection to a compatible LAN. Wireless links may also be implemented. In any such implementation, communication interface 1518 sends and receives electrical, electromagnetic or optical signals that carry digital data streams representing various types of information.

Network link 1520 typically provides data communication through one or more networks to other data devices. For example, network link 1520 may provide a connection through local network 1522 to a host computer 1524 or to data equipment operated by an Internet Service Provider (ISP) 1526. ISP 1526 in turn provides data communication services through the world wide packet data communication network now commonly referred to as the “Internet” 1528. Local network 1522 and Internet 1528 both use electrical, electromagnetic or optical signals that carry digital data streams. The signals through the various networks and the signals on network link 1520 and through communication interface 1518, which carry the digital data to and from computer system 1500, are example forms of transmission media.

Computer system 1500 can send messages and receive data, including program code, through the network(s), network link 1520 and communication interface 1518. In the Internet example, a server 1530 might transmit a requested code for an application program through Internet 1528, ISP 1526, local network 1522 and communication interface 1518.

The received code may be executed by processor 1504 as it is received, and/or stored in storage device 1510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. An apparatus comprising:
one or more processors;
memory storing one or more sequences of instructions which, when executed by the one or more processors, cause the one or more processors to perform:
receiving item identification data and item image data, wherein the item identification data uniquely identifies an item and the item image data comprises a digital representation of the item;
retrieving item attribute data for the item using the item identification data, wherein the item attribute data specifies one or more attributes of the item; and
causing, based upon both at least a portion of the item attribute data and at least a portion of the item image data, auction listing data to be generated and made available via an auction site.

2. The apparatus of claim 1, wherein the instructions that cause retrieving item attribute data for the item using the item identification data further comprise additional instructions which, when executed, cause the one or more processors to perform:
generating a request comprising the item identification data;
transmitting the request to a lookup database service to cause the lookup database service to compare the item identification data with a plurality of data identification data stored in the lookup database service, and
receiving the item attribute data from the lookup database service.

3. The apparatus of claim 1, wherein the instructions that cause auction listing data to be generated at the auction site based upon both at least a portion of the item attribute data and at least a portion of the item image data further comprise additional instructions which, when executed, cause the one or more processors to perform: transmitting to the auction site at least one or more commands that conform to an application program interface of the auction site and both the at least a portion of the item attribute data and the at least a portion of the item image data.

4. The apparatus of claim 1, wherein the auction listing data is accessible, at the auction site, to a user or a group of users for whom the item identification data and the item image data are acquired.

5. The apparatus of claim 1, wherein the instructions that cause receiving item identification data and item image data further comprise additional instructions which, when executed, cause the one or more processors to perform:
monitoring any one of: a file transfer protocol (FTP) folder for data uploaded by a user, an electronic mail folder for data uploaded by a user, and a hypertext transfer protocol (HTTP) post, for data uploaded by a user;
upon detecting that the data is uploaded to any one of: the FTP folder, the electronic mail folder, and the HTTP post, retrieving the item identification data and the item image data from any one of: the FTP folder, the electronic mail folder, and the HTTP post.

6. The apparatus of claim 1, wherein the instructions that cause the receiving, retrieving and causing are performed by a client device that includes one or more data acquisition components for acquiring the item identification data and the item image data.

7. The apparatus of claim 6, wherein the one or more data acquisition components include one or more of a scanner for acquiring the item identification data and a camera for acquiring the item image data.

8. The apparatus of claim 1, further comprising additional instructions which, when executed, cause the one or more processors to perform:
determining whether any one of: receiving the item identification data and the item image data, retrieving item attribute data, and causing action listing data to be generated, was unsuccessful;
in response to determining that any one of: receiving the item identification data and the item image data, retrieving item attribute data, and causing action listing data to be generated, was unsuccessful, generating an error message indicating one or more problems, and transmitting the error message to the auction site.

9. The apparatus of claim 1, wherein the one or more attributes of the item include one or more of: a title, a description, an identifier, a publication date, a condition, an inventory attribute, a price, a color, a size, a shipping date or a return policy.

10. A non-transitory computer-readable storage medium storing one or more sequences of instructions which, when executed by one or more processors, cause the one or more processors to perform:
receiving item identification data and item image data, wherein the item identification data uniquely identifies an item and the item image data comprises a digital representation of the item;
retrieving item attribute data for the item using the item identification data, wherein the item attribute data specifies one or more attributes of the item; and
causing, based upon both at least a portion of the item attribute data and at least a portion of the item image data, auction listing data to be generated and made available via an auction site.

11. The non-transitory computer-readable storage medium of claim 10, wherein the instructions that cause retrieving item attribute data for the item using the item identification data further comprise additional instructions which, when executed, cause the one or more processors to perform:
generating a request comprising the item identification data;
transmitting the request to a lookup database service to cause the lookup database service to compare the item identification data with a plurality of data identification data stored in the lookup database service, and
receiving the item attribute data from the lookup database service.

12. The non-transitory computer-readable storage medium of claim 10, wherein the instructions that cause auction listing data to be generated at the auction site based upon both at least a portion of the item attribute data and at least a portion of the item image data further comprise additional instructions which, when executed, cause the one or more processors to perform: transmitting to the auction site at least one or more commands that conform to an application program interface of the auction site and both the at least a portion of the item attribute data and the at least a portion of the item image data.

13. The non-transitory computer-readable storage medium of claim 10, wherein the auction listing data is accessible, at the auction site, to a user or a group of users for whom the item identification data and the item image data are acquired.

14. The non-transitory computer-readable storage medium of claim 10, wherein the instructions that cause receiving item identification data and item image data further comprise additional instructions which, when executed, cause the one or more processors to perform:
monitoring any one of: a file transfer protocol (FTP) folder for data uploaded by a user, monitoring an electronic mail folder for data uploaded by a user, and monitoring a hypertext transfer protocol (HTTP) post for data uploaded by a user;
upon detecting that the data is uploaded to any one of: the FTP folder, the electronic mail folder, and the HTTP post, retrieving the item identification data and the item image data from any one of: the FTP folder, the electronic mail folder, and the HTTP post.

15. The non-transitory computer-readable storage medium of claim 10, wherein the instructions that cause receiving, retrieving and causing are performed by a client device that includes one or more data acquisition components for acquiring the item identification data and the item image data.

16. The non-transitory computer-readable storage medium of claim 15, wherein the one or more data acquisition components include one or more of a scanner for acquiring the item identification data and a camera for acquiring the item image data.

17. The non-transitory computer-readable storage medium of claim 10, further comprising additional instructions which, when executed, cause the one or more processors to perform:
determining whether any one of: receiving the item identification data and the item image data, retrieving item attribute data, and causing action listing data to be generated, was unsuccessful;
in response to determining that any one of: receiving the item identification data and the item image data, retrieving item attribute data, and causing action listing data to be generated, was unsuccessful, generating an error message indicating one or more problems, and transmitting the error message to the auction site.

18. A method comprising:
receiving item identification data and item image data, wherein the item identification data uniquely identifies an item and the item image data comprises a digital representation of the item;
retrieving item attribute data for the item using the item identification data, wherein the item attribute data specifies one or more attributes of the item; and
causing, based upon both at least a portion of the item attribute data and at least a portion of the item image data, auction listing data to be generated and made available via an auction site;
wherein the method is performed by one or more computing devices.

19. The method of claim 18,
wherein causing auction listing data to be generated at the auction site based upon both at least a portion of the item attribute data and at least a portion of the item image data includes transmitting to the auction site at least one or more commands that conform to an application program interface of the auction site and both the at least a portion of the item attribute data and the at least a portion of the item image data;
wherein the auction listing data is accessible, at the auction site, to a user or a group of users for whom the item identification data and the item image data are acquired.

20. The method of claim 18, further comprising:
determining whether any one of: receiving the item identification data and the item image data, retrieving item attribute data, and causing action listing data to be generated, was unsuccessful;
in response to determining that any one of: receiving the item identification data and the item image data, retrieving item attribute data, and causing action listing data to be generated, was unsuccessful, generating an error message indicating one or more problems, and transmitting the error message to the auction site.
